(19) United States
(12) Patent Application Publication
(10) Pub. No.: US 2010/0161310 A1
(43) Pub. Date: Jun. 24, 2010

(54) TWO-WAY TRANSLATOR STRUCTURE

(76) Inventor: Lin-Sung Chao, Taipei (TW)

Correspondence Address: SCHMEISER OLSEN & WATTS, 18 E UNIVERSITY DRIVE, SUITE # 101, MESA, AZ, 85201, US

(21) Appl. No.: 12/343,956

(22) Filed: Dec. 24, 2008

(51) Int. Cl. G06F 17/28

(52) U.S. Cl. 704/3

(57) ABSTRACT

A two-way translator structure comprises a body having a front surface and a rear surface, and a control circuit installed inside the body and having translation software. The front surface has a display, a voice pick-up element, a voice-output element, and buttons. The rear surface has a display, a voice pick-up element, and a voice-output element. The lateral side of the body has a USB adapter and a memory card adapter. Two persons in dialogue may respectively speak to the voice pick-up elements on the front and rear surfaces. The control circuit translates the speech into another language. The voice-output elements on the front and rear surfaces output the translation voice, and the displays on the front and rear surfaces present the translation text. The translation is stored to a computer via the USB adapter. The user may plug in different memory cards to translate different languages.

### BACKGROUND OF THE INVENTION

1. Field of the Invention

The present invention relates to a two-way translator structure, particularly to a two-way translator, which is capable of real-time two-way translation and expresses the results by voice and text.

2. Description of the Related Art

It is troublesome to communicate with people speaking other languages that we are not familiar with in traveling, shopping or business transactions. A person can handle more than one language, but it is too difficult, if not impossible, to handle all languages. So, in many circumstances, a translator device is used to translate a first user's expression into the text of a second user's language, and then the second user reads the text to learn what the first user expresses. However, the user has to key in the words of his expression, which is troublesome and impractical to those who are not familiar with typing. Based on many years' experience in related fields, the Inventor has been persistently devoted to researches and experiments and finally proposes the present invention to solve the conventional problem and realize real-time two-way translation.

### SUMMARY OF THE INVENTION

The primary objective of the present invention is to provide a two-way translator structure, which translates the speech of a user into another language in real time and presents the translation by voice and text, whereby the user need not key in any word, and wherefore translation is faster and more convenient.

The two-way translator structure of the present invention comprises a body having a front surface and a rear surface and a control circuit installed inside the body and having translation software. The front surface has a display, a voice pick-up element, a voice-output element, and a plurality of buttons. The rear surface has a display, a voice pick-up element, and a voice-output element. The abovementioned components are coupled to the control circuit. Thus is formed the two-way translator structure of the present invention. Two persons in dialogue may speak to the voice pick-up elements on the front and rear surfaces of the translator structure. The translation software in the control circuit translates the speech into another language. The voice-output elements on the front and rear surfaces output the translation voice, and the displays on the front and rear surfaces present the translation text. Thus is achieved a real-time translation.

In the two-way translator structure of the present invention, the lateral side of the body has a USB (Universal Serial Bus) adapter, via which the translation contents are transferred and stored in a computer to assist with learning later.

In the two-way translator structure of the present invention, the lateral side of the body has a memory card adapter to receive memory cards containing different language translation softwares, whereby the present invention can achieve a multi-language translation directly.

In the two-way translator structure of the present invention, the voice pick-up element is a microphone or another element that can pick up voice; the voice-output element is a speaker or another element that can play sounds.

### BRIEF DESCRIPTION OF DRAWINGS

FIG. 1 is a perspective view of a two-way translator structure according to one embodiment of the present invention;

FIG. 2 is another perspective view of a two-way translator structure according to one embodiment of the present invention;

FIG. 3 is a block diagram of the circuit architecture of a two-way translator structure according to one embodiment of the present invention; and

FIG. 4 is a diagram schematically showing the application of the present invention.

### DETAILED DESCRIPTION OF THE INVENTION

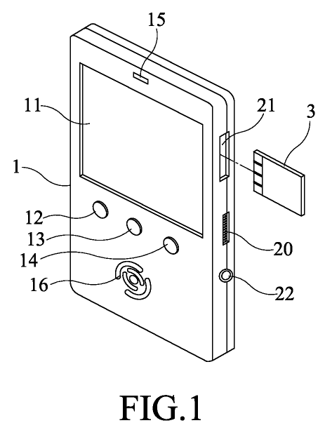

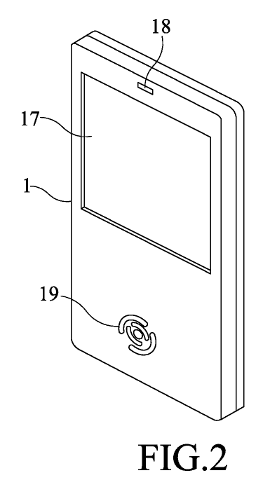

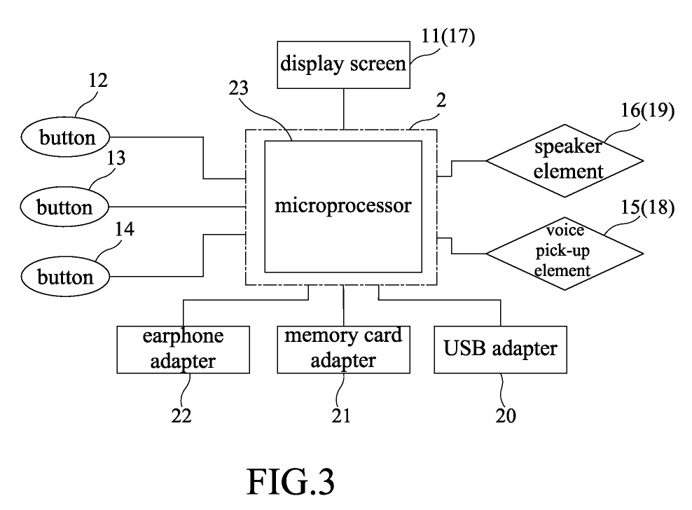

Referring to FIG. 1, FIG. 2 and FIG. 3; the two-way translator structure of the present invention comprises a body 1 having a front surface and a rear surface and a control circuit 2 installed inside the body 1. The control circuit 2 includes a microprocessor 23 containing related software thereinside. The front surface has a display 11, a start button 12, a record button 13, a play button 14, a voice pick-up element 15, and a voice-output element 16, which are all connected to the control circuit 2. The rear surface has a display 17, a voice pick-up element 18, and a voice-output element 19, which are all connected to the control circuit 2 also. Thus is formed a two-way translator structure. The voice pick-up element 15/18 is a microphone or another element that can pick up voice; the voice-output element 16/19 is a speaker or another element that can play sounds.

The lateral side of the body 1 has a USB adapter 20, a memory card adapter 21 and an earphone adapter 22.

Two persons in dialogue may respectively face the front and rear surfaces of the body 1 and speak to the voice pick-up elements 15 and 18. The voice signals are received by the voice pick-up elements 15 and 18 and translated into another language by the software in the control circuit 2. Then, the voice-output elements 16 and 19 output the translation voice; the displays 11 and 17 present the translation text. Thereby, the present invention achieves a real-time translation. Via the USB adapter 20 arranged on the lateral side of the body 1, the microprocessor 23 stores the translation contents into a computer. Later, the user can retrieve the translation contents for language learning. Therefore, the present invention can also assist in language learning. The memory card adapter 21 arranged on the lateral side of the body 1 can receive memory cards 3 containing different language translation softwares. Therefore, the present invention can achieve a multi-language translation function via replacing the memory card 3. Via connecting an earphone to the earphone adapter 22, the user can listen to the stored translation contents.

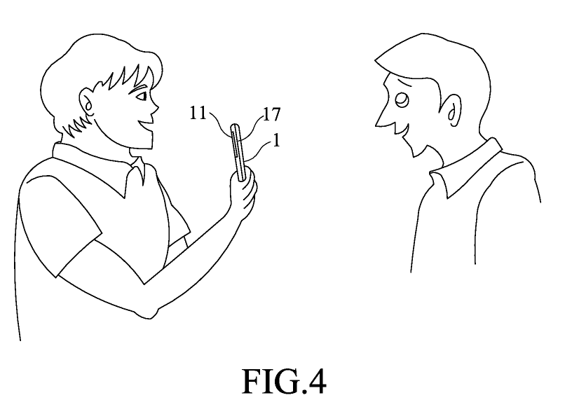

Referring to FIG. 1 and FIG. 4. When using the translator device of the present invention, the user holds the body 1 by his hand and faces the rear surface toward the one he is talking to (a dialogist). When the user pushes the start button 12 and speaks, what he said is translated into another language. The voice-output element 19 outputs the translation voice, and the display screen 17 presents the translation text, for the dialogist in real time. The dialogist may speak to the rear surface of the body 1, and what the dialogist said will be translated into the user's language. The voice-output element 16 outputs the translation voice, and the display screen 11 presents the translation text, for the user in real time. Thus is achieved a real-time translation.

During using the translator device of the present invention, the user may press the record button 13 to save the conversation and translation. The user may press the play button 14 to replay the saved conversation and translation anytime he wants to rehear or exercise the conversation and translation. The conversation and translation can be transferred to and stored in a computer via the USB adapter 20. Later, the user can retrieve the stored conversation and translation for learning language. The user may plug in different memory cards 3 to translate different languages. Therefore, the present invention can support multi-language translation.

In conclusion, the present invention proposes a dual-display, dual-microphone and dual-speaker two-way translator structure, which can perform real-time two-way translation and present the translation by voice and text. The user can easily use the translator device to quickly translate languages because the user need not key in the words of his speech during conversation. It is no doubt that the present invention is a useful innovation. Further, the present invention possesses novelty and non-obviousness and meets the conditions for a patent. Thus, the Inventor files the application for a patent. It will be appreciated if the patent is quickly approved.

What is claimed is:

1. A two-way translator structure, comprising
a body having a front surface and a rear surface;
a control circuit installed inside said body and having a translation software;
a first display arranged on said front surface of said body and electrically coupled to said control circuit;
a first voice pick-up element arranged on said front surface of said body and electrically coupled to said control circuit;
a first voice-output element arranged on said front surface of said body and electrically coupled to said control circuit;
a plurality of buttons arranged on said front surface of said body and electrically coupled to said control circuit;
a second display arranged on said rear surface of said body and electrically coupled to said control circuit;
a second voice pick-up element arranged on said rear surface of said body and electrically coupled to said control circuit;
a second voice-output element arranged on said rear surface of said body and electrically coupled to said control circuit,
wherein when a first user using a first language intends to converse with a second user using a second language, said first user speaks to said first voice pick-up element, and said control circuit receives first-language signals from said first voice pick-up element; said translation software inside said control circuit translates said first-language signals into second-language signals; then, said second display presents text of said second-language signals, and said second voice-output element outputs voices of said second-language signals, and
wherein when said second user intends to reply to said first user, said second user speaks to said second voice pick-up element, and said control circuit receives second-language signals from said second voice pick-up element; said translation software inside said control circuit translates said second-language signals into first-language signals; then, said first display presents text of said first-language signals, and said first voice-output element outputs voices of said first-language signals.

2. The two-way translator structure according to claim 1, wherein said body has a record button and a replay button; a user presses said record button to record conversation and translation and presses said replay button to replay conversation and translation.

3. The two-way translator structure according to claim 1, wherein said body has a USB (Universal Serial Bus) adapter on one side thereof, and translation is stored into a computer via said USB adapter.

4. The two-way translator structure according to claim 1, wherein said body has a memory card adapter on one side thereof, and different translation cards are separately inserted into said memory card adapter to achieve a multi-language translation function.

5. The two-way translator structure according to claim 1, wherein said voice pick-up element is a microphone or a device able to pick up sounds, and said voice-output element is a speaker or a device able to output sounds.
